(19) United States
(12) Patent Application Publication
(10) Pub. No.: US 2005/0225291 A1
(43) Pub. Date: Oct. 13, 2005

(54) Rebalance circuit

(76) Inventor: Guixian Lu, Pontiac, MI (US)

Correspondence Address: Guixian Lu, 853 Melrose Street, Pontiac, MI, 48340, US

(21) Appl. No.: 10/818,534

(22) Filed: Apr. 6, 2004

(51) Int. Cl. H02J 7/00

(52) U.S. Cl. 320/119

(57) ABSTRACT

The present invention utilizes zener diodes and resistor to solve the unbalance problem in large rechargeable battery cells in series. Usually charging and discharging current to the battery is up to couple of hundred amperes. Fans are used to cool down the temperature. Unbalance will happen after a period of charging and discharging.

### BACKGROUND OF THE INVENTION

1. Field of the Invention

The present invention relates to an electronic circuit for rebalancing large rechargeable battery cells in series. After many times of charging and discharging, the capacities of the battery cells are very different. Usually the bigger the capacity of a cell is the higher the voltage of the cell is.

2. Prior Art

There is a traditional way of rebalancing battery cells in series. The traditional way is shown in FIG. 1 where every battery cell is in parallel with one zener diode. The current (pass-by current) will pass by the battery and go through the zener diode, if the voltage of the battery cell exceeds zener voltage. The short-comings of this method are as followings:
a) Because the charging current through the battery may be very big, let say 200 ampere, large zener diodes are required to avoid damage of the zener diodes. That will increase the cost and the size of the battery.
b) Too much current goes through the zener diodes will waste too much energy.

### SUMMARY OF THE INVENTION

The principle object of the present invention is to provide method of using small pass-by current to rebalance battery cells in series.

It also is an object of the present invention to provide a circuit with lower cost and small size.

Another object is to provide such circuit that does not waste too much energy while the battery cells are charged.

The foregoing objects are accomplished by using a parallel circuit in parallel with each group of cell. The parallel circuit consists of a smaller diode and a resistor. The resistor is in series with the zener diode to restrict the pass-by current. The zener voltage is carefully chosen so that ratio of pass-by current time over total charging time is enough to rebalance the battery.

### BRIEF DESCRIPTION OF THE DRAWING

FIG. 1 is the traditional way to rebalance the battery cells. Every cell is in parallel with a zener diode.

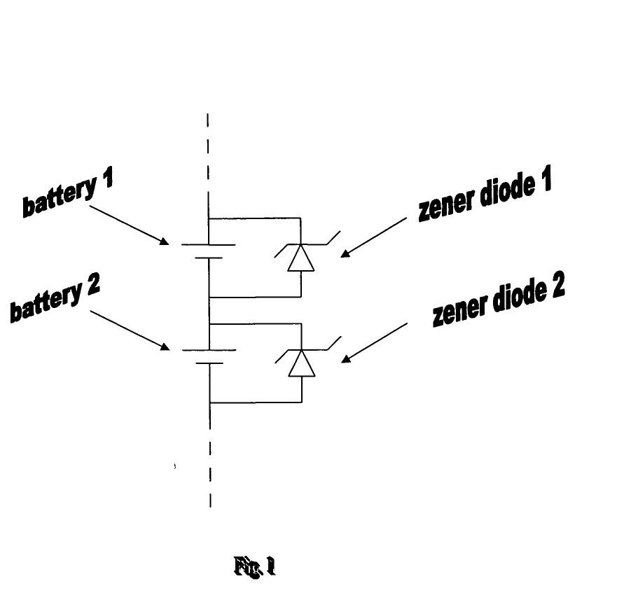

FIG. 2 is the present invention of the charging circuits consisting parallel circuit 1 and parallel circuit 2. Parallel circuit 1 consists of zener diode 1 and resistor 1. Parallel circuit 2 consists of zener diode 2 and resistor 2.

FIG. 3 is the relation between the pass-by current and the voltage of the group.

### DETAILED DESCRIPTION

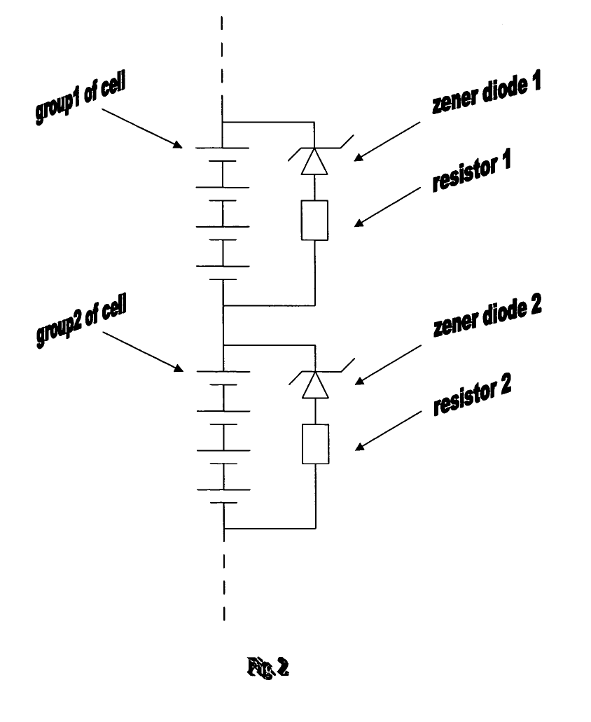

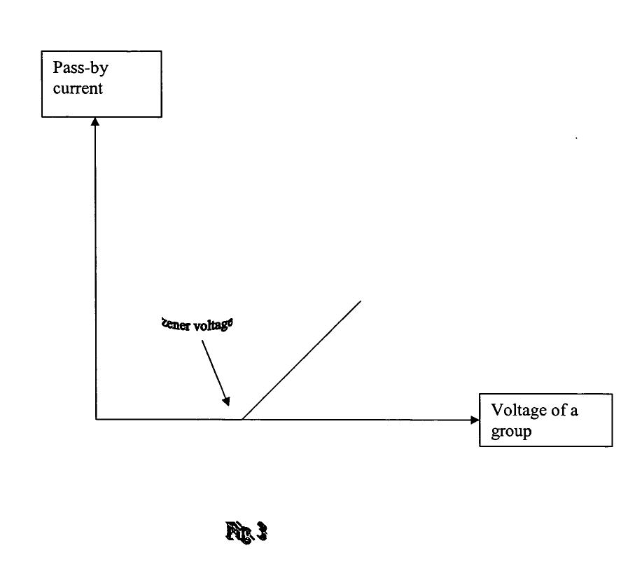

The present invention was originally designed for a hybrid vehicle battery. A hybrid battery box contains about 50 groups, each of which consists of about five rechargeable cells. The differences of the group capacities increase when the temperatures in the groups are different. Rebalance means to reduce the difference between any group voltage and the minimum group voltage to keep the difference within the tolerance. There is a parallel circuit in parallel with each group of cell (at least one cell) in the battery box. Each parallel circuit consists of a zener diode and a resistor in series. (FIG. 2) During charging the battery, voltage of a group of cell is increasing. Before the voltage of the group exceeds the zener voltage, all the charging current goes through the group of cell and there is no pass-by current. If voltage of a group exceeds the zener voltage, a pass-by current goes through the parallel circuit with the group. (see FIG. 3) The pass-by current is equal to the difference of the group voltage and the zener voltage over the resistance value of the resistantor.

The purpose of using the resistor is to reduce the pass-by current as well as the size of the diode. The higher value the resistor is the smaller pass-by current will be. And the higher value the resistor is the smaller zener diode can be used. But too small pass-by current will not be able to rebalance the battery. The higher the zener voltage is chosen the shorter total time of pass-by current will be. The lower the zener voltage is chosen the higher ratio of total pass-by current time over the total charging time will be. The zener voltage and the resistant value of the resistors should be chosen as follows:

The ratio of the total time of pass-by current over the total charging time should be high enough. Pass-by current should be big enough. Generally speaking, integration of pass-by current should be enough to rebalance the battery. In addition to choosing proper resistance and zener voltage, some algorithm may be added to the computer program to control the pass-by current and pass-by current time.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description but rather by the claims appended hereto.

1. A rebalance circuit for rebalancing groups in series of rechargeable cell, consisting at least two parallel circuits, each of which is in parallel with a group of rechargeable battery cell (at least one cell) and consists of at least a zener diode and a resistor.

2. The rebalance circuit of claim 1 wherein the resistant value of said resistor is high enough to reduce the pass-by current so that the size, the weight, and the nominal current of said zener diode will be reduced to acceptable levels.

3. A method of rebalancing groups in series of rechargeable battery cell using a rebalance circuit, consisting at least two parallel circuits, every one of which consists of at least a diode and a resistor, to generate a relative small pass-by current to reduce wasted energy. So said relatively small pass-by current means a current equal to or less than half of the charging current that goes through said groups of rechargeable battery cell.
